(19) United States
(12) Patent Application Publication
(10) Pub. No.: US 2016/0162447 A1
(43) Pub. Date: Jun. 9, 2016

(54) ENHANCED DISTRIBUTION OF DOCUMENTS BASED ON BUSINESS PROCESS FLOWS

(71) Applicant: International Business Machines Corporation, Armonk, NY (US)

(72) Inventors: Todd E. Kaplinger, Raleigh, NC (US); Gal Shachor, Yokneam (IL); Gregory L. Truty, Austin, TX (US)

(21) Appl. No.: 14/560,128

(22) Filed: Dec. 4, 2014

(51) Int. Cl. G06F 17/22; G06F 17/24; G06Q 10/10; H04L 29/08

(52) U.S. Cl. CPC G06F 17/2205; H04L 67/10; G06F 17/24; G06Q 10/10

(57) ABSTRACT

In one embodiment, a computer-implemented method includes receiving first event details from a provider. The first event details are related to a first event in a business process flow associated with a user and related to a user interaction. A first document is generated, by a computer processor, and includes the first event details. The first document is stored in a first set of documents associated with the user. Second event details are received from the provider. The second event details are related to a second event in the business process flow associated with the user and related to the user interaction. The second event is distinct from the first event. A second document is generated and includes the second event details. The second document is stored in the first set of documents associated with the user. The first set of documents is distributed to the user.

### BACKGROUND

Various embodiments of this disclosure relate to digital document distribution and, more particularly, to enhanced distribution of mobile documents based on business process flows.

The Apple® Passbook® is an application that enables users to store passes of various types, including coupons, boarding passes, event tickets, store cards, and other forms of mobile payment. Each pass includes a barcode, enabling the pass to be read and applied for the user's benefit. For example, a pass that acts as a digital boarding pass may be read by airline personnel to allow access to an airplane.

Passbook maintains the passes in a cloud, accessible by a user's computing device, such as a mobile phone, and synched across multiple computing devices of the user. Passbook can notify its user of when a pass is relevant, which is triggered by time and location. For instance, when allowed access to the computing device's global positioning system (GPS), Passbook notifies the user of passes relevant to the user's current location. When a pass applies only during a certain timeframe, Passbook may notify the user of applicability when that timeframe arrives.

Passes can be distributed via email, short message service (SMS), multimedia messaging service (MMS), the web, social media, other applications, or quick response (QR) codes. For instance, a pass may be added to a user's instance of Passbook when the user receives an email and clicks a link within that email to add the email's associated pass to Passbook.

### SUMMARY

In one embodiment of this disclosure, a computer-implemented method includes receiving first event details from a provider. The first event details are related to a first event in a business process flow associated with a user and related to a user interaction. A first document is generated, by a computer processor, and includes the first event details. The first document is stored in a first set of documents associated with the user. Second event details are received from the provider. The second event details are related to a second event in the business process flow associated with the user and related to the user interaction. The second event is distinct from the first event. A second document is generated and includes the second event details. The second document is stored in the first set of documents associated with the user. The first set of documents is distributed to the user.

In another embodiment, a system includes a memory and one or more processors communicatively coupled to the memory. The one or more processors are configured to receive first event details from a provider. The first event details are related to a first event in a business process flow associated with a user and related to a user interaction. The one or more processors are further configured to generate a first document that includes the first event details, and to store the first document in a first set of documents associated with the user. The one or more processors are further configured to receive second event details from the provider. The second event details are related to a second event in the business process flow associated with the user and related to the user interaction. The second event is distinct from the first event. The one or more processors are further configured to generate a second document that includes the second event details, and to store the second document in the first set of documents associated with the user. The one or more processors are further configured to distribute the first set of documents to the user.

In yet another embodiment, a computer program product for distributing digital documents related to a business process flow includes a computer readable storage medium having program instructions embodied therewith. The program instructions are executable by a processor to cause the processor to perform a method. The method includes receiving first event details from a provider. The first event details are related to a first event in a business process flow associated with a user and related to a user interaction. Further according to the method, a first document is generated and includes the first event details. The first document is stored in a first set of documents associated with the user. Second event details are received from the provider. The second event details are related to a second event in the business process flow associated with the user and related to the user interaction. The second event is distinct from the first event. A second document is generated and includes the second event details. The second document is stored in the first set of documents associated with the user. The first set of documents is distributed to the user.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a document distribution system, according to some embodiments of this disclosure;

FIG. 2 is a block diagram showing document associations within the document distribution system, according to some embodiments of this disclosure;

FIG. 3 is a flow diagram of a method for distributing documents, according to some embodiments of this disclosure; and

FIG. 4 is a block diagram of a computing device for implementing some or all aspects of the document distribution system, according to some embodiments of this disclosure.

### DETAILED DESCRIPTION

Various embodiments of this disclosure improve upon Apple's Passbook by distributing and managing not just passes, but also other documents, which may be related to business process flows. While Passbook is limited to distributing scannable passes with which the user can perform an action (e.g., a pass that can be scanned for event or airplane access), some document distribution systems according to this disclosure may distribute not just traditional passes, but also other documents providing notification to keep a user apprised of the state of business process flows. Thus, in some embodiments, not all documents need be passes.

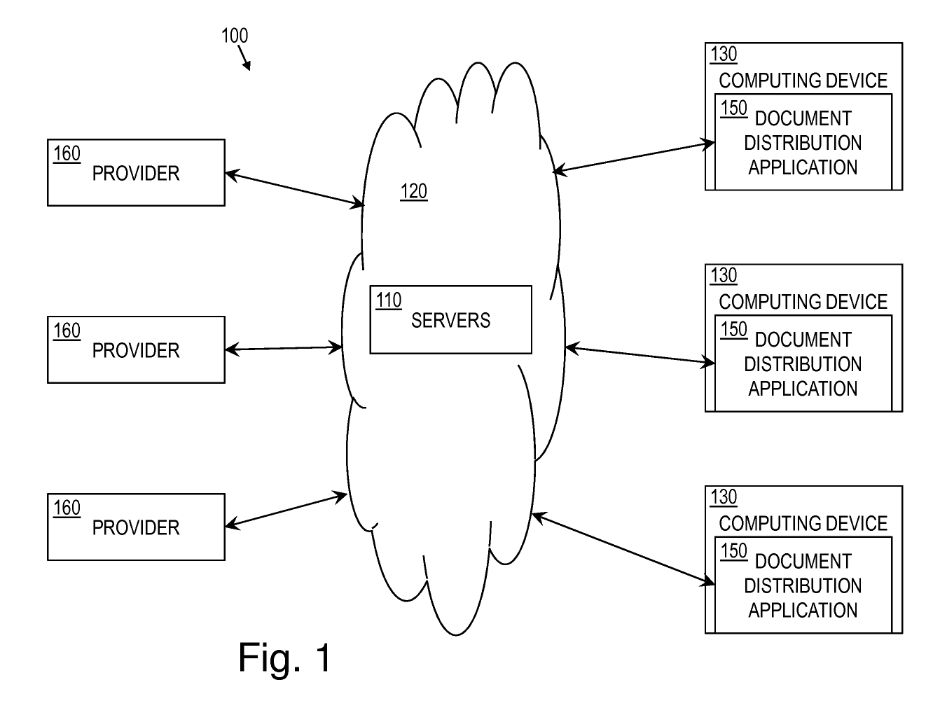

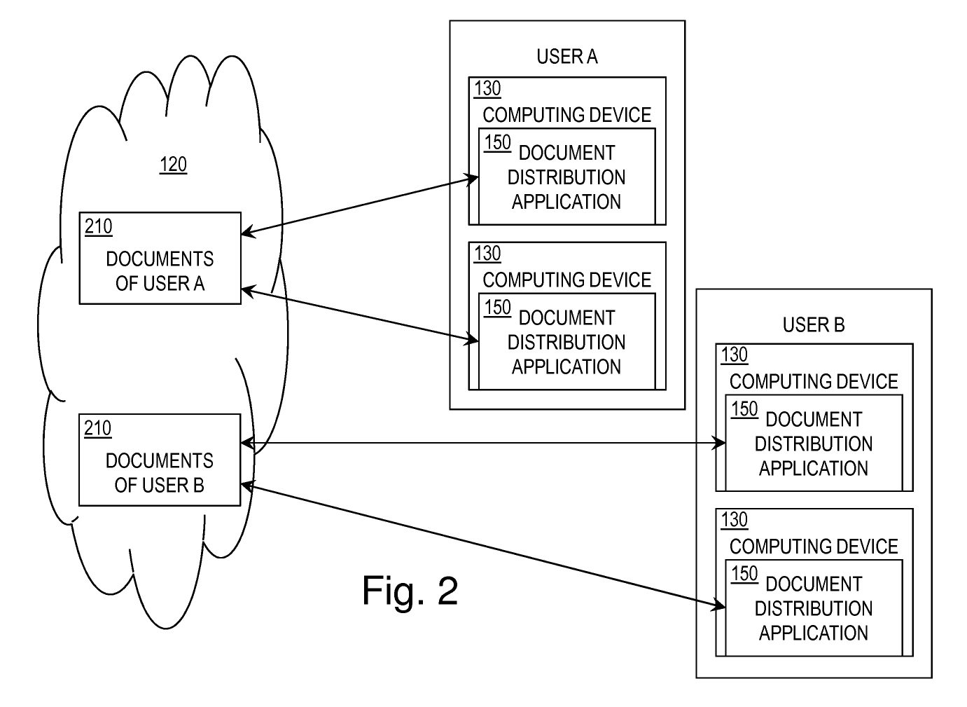

FIG. 1 is a block diagram of a document distribution system 100, according to some embodiments of this disclosure. As shown, the document distribution system 100 may be embodied, at least in part, in one or more servers 110, which may together form a computing cloud 120 for maintaining data, including documents 210 (FIG. 2). The computing cloud 120 may be in communication with one or more computing devices 130, each being operable by a user and each being configured to run a document distribution application 150. An instance of the document distribution application 150 running on a particular computing device 130 may manage operations of the document distribution system 100 that are local to that computing device 130.

FIG. 2 is a block diagram showing document associations in the document distribution system 100, according to some embodiments of this disclosure. As shown, the computing cloud 130 may store a plurality of documents 210, each associated with a user. Each user may be associated with a set of one or more documents 210. The documents 210 associated with a particular user may be synched across the computing devices 130 of that user. For instance, as shown in FIG. 2, the documents 210 associated with User A may be synched across all of User A′s computing devices 130, while the documents 210 associated with User B may be synched across all of User B′s computing device 130.

Returning back to FIG. 1, the computing cloud 120 may also be in communication with one or more providers 160, which may provide the documents 210 associated with the users. Thus, each document 210 may be associated with the provider 160 who provided that document, as well as with the user to whom the document 210 is directed.

In some embodiments, a document 210 may be issued by a provider 160 in response to a user's interaction with the provider 160, which may be through an entity associated with the provider 160. For instance, upon receiving an interaction from a user, a provider 160 may deliver one or more documents 210 to the computing cloud 120, indicating that such documents 210 are directed toward the user. The computing cloud 120 may deliver the documents 210 to one or more instances of the document distribution application 150 on the user's one or more computing devices 130. More specifically, in some embodiments, the provider 160 may send the documents 210 one at a time, timed with events in its business process flow while processing the interaction from the user. The computing cloud 120 may then store the documents 210 and synchronize them across the user's computing devices 130 by transmitting them to those computing devices 130.

In some embodiments, each document 210 of the document distribution system 100 may be based on a template, which may be the same across all documents 210 or may vary across providers 160. For example, and not by way of limitation, according to a template, each document 210 may include a set of items, such as a provider identifier, an initial user interaction, event details, and an action item. The provider identifier may be a name or other identifier of the provider 160 with which the document 160 is associated. The initial user interaction may identify the user interaction from which this document 210 is a result (e.g., purchasing an airplane ticket). The event details may provide the user with details about the event within the business process flow that resulted in the document 210 being issued. Mare particularly, in some cases, the event details may explain the purpose of the document 210 (e.g., indicating the document 210 is a boarding pass). The action item may be a component enabling the user to take an action based on the document 210. For example, the action item may be a hyperlink or a barcode, such as a linear barcode or QR code. In some embodiments, the various items of the document 210 may have fixed locations from document 210 to document 210 based on the template. In some embodiments, in some documents 210, one or more of these example items may be left blank or empty within a document 210.

If a template is being used, then when delivering a document 210 to the computing cloud 120, a provider 160 may deliver the document 210 in the form of event details to be included in the template. The computing cloud 210 may then assemble this data or event details into the template to generate the form of the document 210 delivered to the user. Thus, throughout this disclosure, references to a provider 160 issuing a document 210 may also refer to the case where the provider provides event details to be placed into a document 210.

As mentioned above, the document distribution application 150 may be installed on a computing device 130. The document distribution application 150 may be in communication with the computing cloud 120 and may locally manage and display the documents 210 associated with a user who is logged into the document distribution application 150 locally. When a user initially logs into the document distribution application 150, the document distribution application 150 may access the computing cloud 120 to retrieve the documents 210 currently associated with the user. When the document distribution application 150 starts up or otherwise becomes active, at a time after initial login, the document distribution application 150 may check with the computing cloud 120 to determine whether new documents 120 were issued to the user since the document distribution application 150 was last active. If so, the document distribution application 150 may retrieve those new documents 210. In this manner, a user's documents 210 may remain synchronized across multiple devices 130 of the user.

When a new document 210 is issued to the user, the computing cloud 120 may store this document 210 in association with the user and may notify each active document distribution application 150 of the user. This notification may take various forms. For example, the computing cloud 120 may transmit the document 210 to the document distribution application 150 on the computing device 130 without prompting by the document distribution application 150. For another example, the computing cloud 120 may notify the document distribution application 150 that the new document 210 has been received, and the document distribution application 150 may initiate retrieval of the document 210 in its own time. In both of these example, the computing cloud 120 may notify the document distribution application 150 using, for example, push notification or pull notification.

In some embodiments, the document distribution application 150 need not display all documents 210 available to it at once. Rather, the document distribution application 150 may select which documents 210 to display to the user based on which documents 210 are deemed relevant to the user's current situation. For example, and not by way of limitation, documents 210 may be displayed based on time or location, which may be determined by the computing device 130. For instance, a document 210 that is a boarding pass may be displayed by the document distribution application 150 when the user's location is deemed to be within the vicinity of an airport.

Additionally, to avoid locally maintaining documents 210 unnecessarily, the document distribution application 150 may remove documents 210 from time to time. Removal may be performed, for example, by deleting a document 210 from the document distribution application 150 and from the computing cloud 120, or by archiving a document 210 by deleting only the local copy. A document 210 may be removed automatically when it times out. For example, in the case of a boarding pass, a document 210 may be deemed to have timed out after the aircraft takes off or when boarding ends. For another example, a document 210 may be removed in response to an instruction manually provided by the user regarding that specific document 210 or a group of documents to which that specific document 210 belongs. In some embodiments, the document distribution application 150 may be customizable by the user, enabling the user to provide instructions regarding the criteria used to determine when a document 210 is removed.

Embodiments of the document distribution application 150 may apply in many contexts and to many types of business flows. Some illustrative examples are provided below.

For example, as an initial interaction, a user may purchase an airplane ticket from an airline that is, or is associated with, a provider 160. The provider 160 may become aware of one or more events related to this initial interaction. For instance, the provider 160 may receive the ticket order, assign a seat to the user, reschedule takeoff time, open for check-in, assign a boarding pass to the user, and begin boarding the aircraft. Each of these events may be part of the business process flow of the provider 160 that is applicable to the user due, at least in part, to the user's initial interaction with the provider 160. At each of these events, the provider 160 may issue a new document 210 to the user, which may or may not be actionable.

More specifically, when the ticket order is initially received, the provider 160 may issue a document 210 verifying receipt of the ticket order. This document 210 may include an action item enabling the user to modify this order (e.g., a link to a web page for modifying the order), for example. When the user is assigned a seat on an airplane, the provider 160 may issue a document 210 indicating the seat assignment. This document 210 may include an action item enabling the user to modify the seat assignment, for example. If the takeoff time of the flight is rescheduled, the provider 160 may issue a document 210 indicating the new takeoff time. This document 210 may include an action item providing customer service contact information, for example. When the flight is open for check-in, the provider 160 may issue a document 210 indicating that check-in is now available. This document 210 may include an action item enabling the user to check in for the upcoming flight (e.g., a link to a web page for checking in), for example. After the user has checked in, the provider 160 may issue a document 210 that is a digital boarding pass. This document 210 may include an action item, such as a barcode, that may be scanned to verify the boarding pass. The airline personnel may read, e.g., scan, that action item before allowing the user on the aircraft. When the aircraft for which the user has purchased a ticket begins boarding for the user's flight, the provider 160 may issue a document 210 indicating that boarding has begun. It will be understood that the documents 210 issued according to events in this business process flow may vary from the above, and may include other documents 210 instead of or in addition to those above.

For another example, as an initial interaction, a user may apply for a loan from a provider 160 or an entity associated with a provider 160. The provider 160 may become aware of one or more events related to this initial interaction. For instance, the provider 160 may receive the loan application, begin processing the loan application, request more information, and decide on the loan application. Each of these events may be part of the business process flow of the provider 160 that is applicable to the user due, at least in part, to the user's initial interaction with the provider 160. At each of these events, the provider 160 may issue a new document 210 to the user, which may or may not be actionable.

More specifically, when the loan application is initially received, the provider 160 may issue a document 210 verifying receipt of the application. This document 210 may include an action item enabling the user to modify the application (e.g., a link to a web page for modifying the application), for example. When processing of the application begins, the provider 160 may issue a document 210 indicating that the application is being processed. If it is determined that more information is needed from the user to make a decision on the application, the provider 160 may issue a document 210 requesting more information. This document 210 may include an action item enabling the user to upload, or otherwise provide, the requested additional information. When a decision is made on the loan application, the provider 160 may issue a document 210 indicating the decision. For example, if the decision is an approval, this document 210 may include an action item enabling the user to accept the loan funds, for example. It will be understood that the documents 210 issued according to events in this business process flow may vary from the above, and may include other documents 210 instead of or in addition to those above.

For yet another example, as an initial interaction, a user may place an order for goods or services, associated with a provider 160. The provider 160 may be aware of one or more events related to this initial interaction. For instance, the provider 160 may receive an order from the user, begin processing the order, ship a package containing the item ordered, and acquire one or more shipping updates. Each of these events may be part of the business process flow of the provider 160 that is applicable to the user due, at least in part, to the user's initial interaction with the provider 160. At each of these events, the provider 160 may issue a new document 210 to the user, which may or may not be actionable.

More specifically, when the order for an item is received, the provider 160 may issue a document 210 confirming the order. This document 210 may include an action item enabling the user to modify the order (e.g., a link to a web page for modifying the order), for example. When processing of the order begins, the provider 160 may issue a document 210 indicating that the order is being processed. When a package with the ordered item is shipped to a location specified in the order, the provider 160 may issue a document 210 indicating that shipment has been made. This document 210 may include an action item enabling the user to track the package or to receive further shipment updates from the provider 160. In the latter case, the provider 160 may issue another document 210 for each of one or more tracking updates for the shipment, including for example, a document 210 indicating the package was delivered. It will be understood that the documents 210 issued according to events in this business process flow may vary from the above, and may include other documents 210 instead of or in addition to those above.

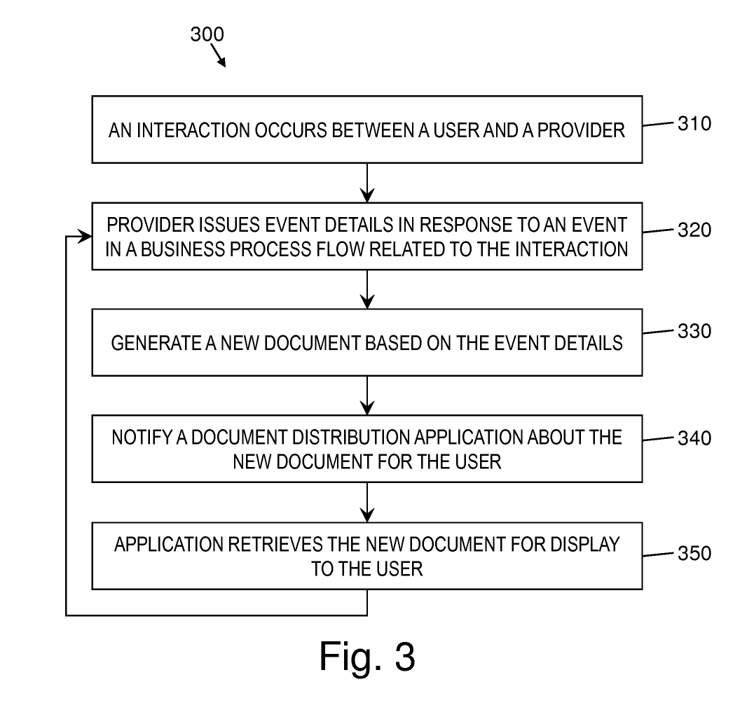

FIG. 3 is a flow diagram of a method 300 for distributing documents 210, according to some embodiments of this disclosure. As shown, at block 310, an interaction may occur between a user and a provider 160. At block 320, the provider 160 may issue event details in response to an event in a business process flow related to the interaction. At block 330, the computing cloud 120 may generate a document 210 based on the event details. The document 210 may or may not be an actionable pass. At block 340, the computing cloud 120 may notify an instance of the document distribution application 150 that a new document 210 was issued for the user. At block 350, the document distribution application 150 may retrieve the issued document 210 for local viewing by the user. Blocks 320 through 350 may be repeated for each event for which the provider 160 opts to distribute a document 210. It will be understood that other methods are also within the scope of this disclosure.

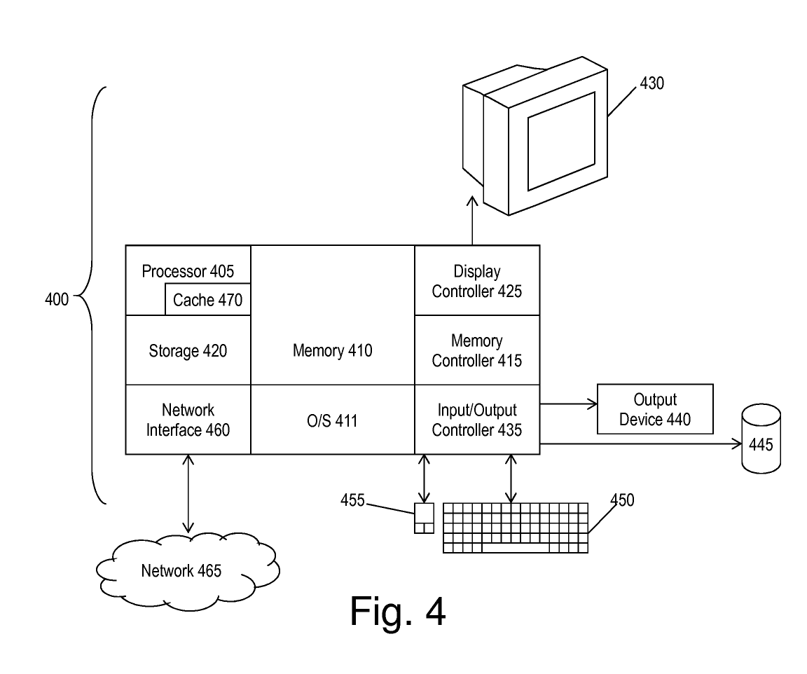

FIG. 4 illustrates a block diagram of a computer system 400 for use in implementing a document distribution system or method according to some embodiments. The document distribution systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 400, such as a personal computer, workstation, minicomputer, or mainframe computer. For example, and not by way of limitation, the one or more servers 110 may be computer systems 400, as may be the one or more computing devices 130.

In an exemplary embodiment, as shown in FIG. 4, the computer system 400 includes a processor 405, memory 410 coupled to a memory controller 415, and one or more input devices 445 and/or output devices 440, such as peripherals, that are communicatively coupled via a local I/O controller 435. These devices 440 and 445 may include, for example, a printer, a scanner, a microphone, and the like. A conventional keyboard 450 and mouse 455 may be coupled to the I/O controller 435. The I/O controller 435 may be, for example, one or more buses or other wired or wireless connections, as are known in the art. The I/O controller 435 may have additional elements, which are omitted for simplicity, such as controllers, buffers (caches), drivers, repeaters, and receivers, to enable communications.

The I/O devices 440, 445 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 405 is a hardware device for executing hardware instructions or software, particularly those stored in memory 410. The processor 405 may be any custom made or commercially available processor, a central processing unit (CPU), an auxiliary processor among several processors associated with the computer system 400, a semiconductor based microprocessor (in the form of a microchip or chip set), a macroprocessor, or other device for executing instructions. The processor 405 includes a cache 470, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 470 may be organized as a hierarchy of more cache levels (L1, L2, etc.).

The memory 410 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 410 may incorporate electronic, magnetic, optical, or other types of storage media. Note that the memory 410 may have a distributed architecture, where various components are situated remote from one another but may be accessed by the processor 405.

The instructions in memory 410 may include one or more separate programs, each of which comprises an ordered listing of executable instructions for implementing logical functions. In the example of FIG. 4, the instructions in the memory 410 include a suitable operating system (OS) 411. The operating system 411 essentially may control the execution of other computer programs and provides scheduling, input-output control, file and data management, memory management, and communication control and related services.

Additional data, including, for example, instructions for the processor 405 or other retrievable information, may be stored in storage 420, which may be a storage device such as a hard disk drive or solid state drive. The stored instructions in memory 410 or in storage 420 may include those enabling the processor to execute one or more aspects of the document distribution systems and methods of this disclosure.

The computer system 400 may further include a display controller 425 coupled to a display 430. In an exemplary embodiment, the computer system 400 may further include a network interface 460 for coupling to a network 465. The network 465 may be an IP-based network for communication between the computer system 400 and any external server, client and the like via a broadband connection. The network 465 transmits and receives data between the computer system 400 and external systems. In an exemplary embodiment, the network 465 may be a managed IP network administered by a service provider. The network 465 may be implemented in a wireless fashion, e.g., using wireless protocols and technologies, such as WiFi, WiMax, etc. The network 465 may also be a packet-switched network such as a local area network, wide area network, metropolitan area network, the Internet, or other similar type of network environment. The network 465 may be a fixed wireless network, a wireless local area network (LAN), a wireless wide area network (WAN) a personal area network (PAN), a virtual private network (VPN), intranet or other suitable network system and may include equipment for receiving and transmitting signals.

Document distribution systems and methods according to this disclosure may be embodied, in whole or in part, in computer program products or in computer systems 400, such as that illustrated in FIG. 4.

For some embodiments of this disclosure, technical effects and benefits can include tying convenient document distribution to events in business process flows. As compared to existing mechanisms, such as Passbook, the present document distribution system 100 may have wider applicability and higher utility, due to being related to more than just passes.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving first event details from a provider, the first event details related to a first event in a business process flow associated with a user and related to a user interaction;
generating, by a computer processor, a first document that includes the first event details;
storing the first document in a first set of documents associated with the user;
receiving second event details from the provider, the second event details related to a second event in the business process flow associated with the user and related to the user interaction, the second event distinct from the first event;
generating a second document that includes the second event details;
storing the second document in the first set of documents associated with the user; and
distributing the first set of documents to the user.

2. The method of claim 1, wherein distributing the first set of documents to the user comprises transmitting the first set of documents to a document distribution application associated with the user.

3. The method of claim 1, further comprising synchronizing the first set of documents across two or more computing devices of the user.

4. The method of claim 1, further comprising displaying to the user a subset of the first set of documents, wherein the subset is selected based on at least one of the current time and the current location.

5. The method of claim 1, further comprising:
receiving a plurality of additional event details from a plurality of additional providers; and
associating the plurality of additional event details with a plurality of additional users.

6. The method of claim 1, wherein the first document is a notification absent an actionable pass.

7. A system comprising:
a memory; and
one or more processors, communicatively coupled to the memory, the one or more processors configured to:
receive first event details from a provider, the first event details related to a first event in a business process flow associated with a user and related to a user interaction;
generate a first document that includes the first event details;
store the first document in a first set of documents associated with the user;
receive second event details from the provider, the second event details related to a second event in the business process flow associated with the user and related to the user interaction, wherein the second event is distinct from the first event;
generate a second document that includes the second event details;
store the second document in the first set of documents associated with the user; and
distribute the first set of documents to the user.

8. The system of claim 7, wherein to distribute the first set of documents to the user comprises to transmit the first set of documents to a document distribution application associated with the user.

9. The system of claim 7, the one or more processors being further configured to synchronize the first set of documents across two or more computing devices of the user.

10. The system of claim 7, the one or more processors being further configured to display to the user a subset of the first set of documents, wherein the subset is selected based on at least one of the current time and the current location.

11. The system of claim 7, the one or more processors being further configured to:
receive a plurality of additional event details from a plurality of additional providers; and
associate the plurality of additional event details with a plurality of additional users.

12. The system of claim 7, wherein the first document is a notification absent an actionable pass.

13. A computer program product for distributing digital documents related to a business process flow, the computer program product comprising a computer readable storage medium having program instructions embodied therewith, the program instructions executable by a processor to cause the processor to perform a method comprising:
receiving first event details from a provider, the first event details related to a first event in a business process flow associated with a user and related to a user interaction;
generating a first document that includes the first event details;
storing the first document in a first set of documents associated with the user;
receiving second event details from the provider, the second event details related to a second event in the business process flow associated with the user and related to the user interaction, wherein the second event is distinct from the first event;
generating a second document that includes the second event details;
storing the second document in the first set of documents associated with the user; and
distributing the first set of documents to the user.

14. The computer program product of claim 13, wherein distributing the first set of documents to the user comprises transmitting the first set of documents to a document distribution application associated with the user.

15. The computer program product of claim 13, the method further comprising synchronizing the first set of documents across two or more computing devices of the user.

16. The computer program product of claim 13, the method further comprising displaying to the user a subset of the first set of documents, wherein the subset is selected based on at least one of the current time and the current location.

17. The computer program product of claim 13, the method further comprising:
receiving a plurality of additional event details from a plurality of additional providers; and
associating the plurality of additional event details with a plurality of additional users.

18. The computer program product of claim 13, wherein the first document is a notification absent an actionable pass.
